(19) United States
(12) Patent Application Publication
(10) Pub. No.: US 2008/0183910 A1
(43) Pub. Date: Jul. 31, 2008

(54) Personal medical device (PMD) docking station

(76) Inventors: Joseph D. Natoli, Phoenix, AZ (US); David Poisner, Folsom, CA (US)

Correspondence Address: DARBY & DARBY P.C., P.O. BOX 770, Church Street Station, New York, NY, 10008-0770, US

(21) Appl. No.: 11/646,603

(22) Filed: Dec. 28, 2006

(51) Int. Cl. G06F 3/00; G06F 13/00

(52) U.S. Cl. 710/15; 710/303

(57) ABSTRACT

A method and system for controlling and monitoring various functions of a personal medical device attached to a docking station, wherein the docking station may include technology to provide power, incremental I/O, control signals and/or a secured physical receptacle for various personal medical devices, and the docking station may be associated with a particular location in a healthcare facility, such as an x-ray room, or it may be associated with an apparatus such as a hospital bed or a wheelchair.

### FIELD OF THE INVENTION

The invention is in the field of personal medical devices.

### BACKGROUND OF THE INVENTION

In today's world of growing health care, it is becoming more important than ever to be able to accurately manage and track a patient throughout the patient's stay at a health care facility, such as a large metropolitan hospital. Many different methods and devices have been devised and utilized in an effort to achieve this lofty goal.

### BRIEF SUMMARY OF THE INVENTION

According to various embodiments of the invention, a docking station may include at least one connector to form a connection between a personal medical device and the docking station; and a data exchange unit to transmit data to the personal medical device; wherein the data comprises control information to control at least one operating parameter of the personal medical device.

According to various embodiments of the invention, the connector is to form a wired connection between a personal medical device to the docking station.

According to various embodiments of the invention, the connector is to form a wireless connection between a personal medical device to the docking station.

According to various embodiments of the invention, the data exchange unit receives data from the personal medical device.

According to various embodiments of the invention, the data further comprises geo-location data to calibrate a geo-location unit of the personal medical device.

According to various embodiments of the invention, the operating parameters of the personal medical device comprises at least one of a biometric sampling, a biometric sampling rate, a geo-locator positioning operation, and a geo-locator reporting operation.

According to various embodiments of the invention, the at least one operating parameter of the personal medical device is a transmission state, such that a transmission unit of 2. The docking station of claim 1, the personal medical device is disabled while the personal medical device is connected with the docking station.

According to various embodiments of the invention, the connection uses one of a Bluetooth based technology, an NFC based technology and an RFID based technology.

According to various embodiments of the invention, the connection is only established while the personal medical device is physically connected to the docking station.

According to various embodiments of the invention, a system may include a plurality of the docking stations, wherein at least two of the docking stations control the at least one operating parameter to be in a different state.

According to various embodiments of the invention, the plurality of docking stations are located in a hospital or medical clinic.

According to various embodiments of the invention, at least one docking station is mounted to a wheelchair.

According to various embodiments of the invention, at least one docking station is mounted to a bed.

According to various embodiments of the invention, a system may further include a processor unit to receive data from the personal medical device.

According to various embodiments of the invention, a system may further include a processor unit to receive data from the plurality of docking stations.

According to various embodiments of the invention, the dock is connected to a biometric monitoring device and a patient care device, and wherein the personal medical device is configured to; monitor the biometric monitoring device, analyze data received from the biometric monitoring device, determine which patient care device is attached to the dock, determine if the patient care device should be controlled based on the analyzed data, and control the patient care device in response to a determination that the patient care device should be controlled.

According to various embodiments of the invention, a method may include controlling at least one operating parameter of a personal medical device based on a control signal received from a docking station.

According to various embodiments of the invention, the operating parameters of the personal medical device comprises at least one of a biometric sampling, a biometric sampling rate, a geo-locator positioning operation, and a geo-locator reporting operation.

According to various embodiments of the invention, the at least one operating parameter of the personal medical device is a transmission state, such that a transmission unit of the personal medical device is disabled while the personal medical device is connected with the docking station.

According to various embodiments of the invention, a method may include monitoring at least one biometric monitoring device connected to a dock, analyzing data received from the biometric monitoring device using a personal medical device, determining at least one patient care device is attached to the dock using a personal medical device, determining if the patient care device should be controlled based on the analyzed data using a personal medical device, and controlling the patient care device in response to a determination that the patient care device should be controlled using a personal medical device.

According to various embodiments of the invention, a manual input is required prior to controlling the patient care device.

According to various embodiments of the invention, the manual input can be performed at a remote location.

### BRIEF DESCRIPTION OF THE DRAWINGS

FIG. 1 depicts an exemplary system in which a PMD is attached to a bed-side dock according to an embodiment of the invention.

FIG. 2 depicts an exemplary system in which a PMD is attached to a wheelchair dock according to an embodiment of the invention.

### DETAILED DESCRIPTION OF THE INVENTION

In order to supply more efficient and effective healthcare, a system has been developed to enhance the abilities of personal medical devices (hereinafter, “PMD's”). A PMD may typically be a hand-held computing platform that may be assigned to a patient when the patient checks-in to a hospital or other care setting. While it is preferred that each patient be assigned a PMD, it is not necessary. In some instances, only patients requiring at least a set amount of care may be assigned a PMD.

According to an embodiment of the invention, a PMD may perform at least the following three functions:

Patient geo-location: Patient geo-location enables the PMD to determine a patient's location. The location may be determined relative to a global position using various known systems, such as GPS, or location may be determined relative to the physical facility the patient is in or to various devices or places within the facility. Regardless of how a patient's position is located, doing so allows the patient's location to be tracked electronically by an associated processor based system, thereby allowing various healthcare professionals to quickly determine where a specific patient is located at any given time.

Data aggregation—A PMD may be enabled to collect and/or normalize medical device data regarding a patient and to make the data available across hospital systems. Not only can a PMD track a patient's movements, but the PMD may also be capable of recording medical data, such as biometric data. Data may be input into a PMD manually, or according to alternate embodiments, medical devices, such as blood pressure monitors and heart rate detectors, may be connected directly to a PMD such that monitored data may be automatically input into the PMD. Once input into the PMD, data may be stored in a memory device, such as a static memory or a hard drive. The data may also be transmitted to a centralized system in several ways. Data may be transmitted constantly, at specific times or in conjunction with certain events, such as every time a PMD is connected to a docking station as discussed below.

Decision engine—Based on the patient's location, a state of data aggregation and a set of protocols involving various medical related activities, a PMD may be enabled to automatically determine whether certain events related to key aspects of patient care should occur. For example, based on a set of parameter stored in a PMD and various patient data, the PMD may determine that alarms should be initiated or that settings on related medical devices should be adjusted. According to further embodiments medication may be distributed to a patient based on the medical data and stored protocols.

Various features of the invention may be enabled using various combinations of hardware, software and/or firmware.

According to various embodiments of the invention, a PMD may include: a power unit, such as a battery; a memory, such as a hard drive or a Flash EPROM; a processor to execute instructions from its programming; and a transmission unit to transfer data between the PMD and a variety of external devices.

The PMD may also communicate with external devices using wireless and/or wired technology. These devices may be used to monitor a user's temperature, motion, respiration, blood oxygen content, electrocardiogram, electroencephalogram and/or other measurements.

The PMD may also transmit data to an external device using changes in voltage, impedance, current, magnetic field, electromagnetic energy (such as radio frequency signals, infrared signals or optical signals), and/or audible signals. Data may be transmitted in a variety of ways, including, but not limited to analog or digital transmission.

Data may be transmitted using a variety of data ports, including serial, parallel and USB ports, among other well known types.

The PMD may also utilize an interface unit, such as a graphical user interface unit, to allow a user to view data or other information stored or monitored by the PMD, and to allow the user to control various functions of the PMD, such as data transfer and manipulation. The PMD may also contain a non-graphical interface such as an audible interface which may include voice recognition technology.

The interface unit may include a display device such as a CRT, plasma display, LED, LCD, etc.

The PMD may include a data input device, such as a keypad, touch screen, bar code scanner, telephone keypad, button set, switch set, etc.

The PMD may include a camera device, such as a still camera and/or a video camera.

According to various embodiments of the invention, a system utilizing a PMD and a PMD docking station is preferred. A docking station may include technology to provide power, incremental I/O, control signals and/or a secured physical receptacle for various PMD's. A docking station may be associated with a particular location in a healthcare facility, such as an x-ray room, or it may be associated with an apparatus such as a hospital bed or a wheelchair. A dock may support or enhance various functionalities (power, I/O and receptacle) of a PMD depending on the dock's placement and purpose. For example, an ICU bed-side dock may provide a receptacle, power, and PAN/WAN I/O for medical systems, while a wheelchair dock may be configured to provides only a physical receptacle.

A dock may be configured to communicate its capabilities to the PMD and the PMD platform may adjust its behavior and policies based on the capabilities communicated by the dock. For example, in a bed-side configuration it may be important that the PMD timely record and communicate vital signs captured by medical equipment but, considering that a bed is generally stationary, the dock may only report geo-location every 20 minutes. However, when a dock is connected to a wheelchair, geo-location reporting timing may be more critical due to the mobile nature of a wheelchair. Accordingly, a wheelchair dock may be configured to report a geo-location more frequently, perhaps every 15 seconds.

Furthermore, a dock may be configured to provide a PMD with an exact location of the dock, such as an XYZ location to enable the PMD to recalibrate its geo-locator. Certain systems, such as GPS, generally have an inherent inaccuracy. By providing an exact location, the dock may allow a PMD to adjust for the inaccuracy such that a more correct location is determined.

A PMD may be provided with a system to determine if it remains within a certain proximity of the patient to which it is associated. This may be done by attaching a device to a patient, such as a bracelet or a necklace and then using various technologies, some of which are described below, to determine if the PMD stays within a certain range of the device. If the PMD is located outside of the predetermined range, an audible, visible or even motion alarm may be initiated and maintained until the PMD is brought back into range, or until the alarm is disabled. Such a system may be beneficial in that it may aid a patient of caregiver in remembering to transfer a PMD from one dock to another when a patient is moved.

According to various embodiments of the invention, a PMD itself may be attached to a user. In such a system, the PMD may communicate wirelessly with a dock to transmit data and/or control signal.

According to various embodiments of the invention, a dock may not be configured to supply power to a PMD. Such docks may be preferred in locations where it is not advisable to have a power system, or where it is not convenient to supply power, such as a wheelchair.

According to various embodiments of the invention, specialized docks may be located in ambulances such that real time data may be transmitted. This data may be transmitted to a receiving hospital's computer system or to a doctor who is monitoring the patient's transfer.

According to various embodiments of the invention, docks in certain transmission sensitive location may disable an associated PMD's transmission capabilities to prevent interference with sensitive equipment. In some such embodiments, the dock may transmit information to/from the PMD using a wired system.

According to various embodiments of the invention, the PMD and dock may form part of a closed loop feedback system in which the PMD can be used to monitor a patient's status through attached devices, and can then use the acquired data to determine if the settings of at least one attached device should be altered and adjust the device accordingly. For example, a PMD may be used to acquire a blood oxygen level using a pulse-ox meter attached to a dock. If the PMD determines that the blood oxygen levels are falling below a predetermined level, the PMD may determine that an oxygen supply is attached to the dock and that the oxygen flow should be increased. The PMD may then adjust the attached oxygen supply to increase the oxygen flow.

According to additional embodiments of the invention, a PMD may be remotely monitored and controlled by a doctor such that the doctor may be informed that the PMD has detected certain parameters and recommends a certain course of action. The doctor may then be asked to confirm the action before it is taken. In the above example, a doctor may be informed of the drop in blood oxygen, the doctor may then be informed which devices are attached to the associated dock, and presented with the recommended action of increasing oxygen flow. If the doctor approves of the recommendation, the oxygen flow may be increased. According to additional embodiments, the doctor may be able to control the attached devices independently of any recommendation by the PMD.

According to various embodiments of the invention, a docking station may include at least one connector to form a connection between a personal medical device and the docking station; and a data exchange unit to transmit data to the personal medical device; wherein the data comprises control information to control at least one operating parameter of the personal medical device.

According to various embodiments of the invention, a method may include controlling at least one operating parameter of a personal medical device based on a control signal received from a docking station.

According to various embodiments of the invention, both the dock and the PMD have a hardware and software stack that supports the communication of capabilities, state, and resulting policy. The above described systems are not limited to healthcare environments and may be utilized in other verticals where device context and its resulting behavior are desired.

According to various embodiments of the invention, clinical care settings are enabled to implement a patient monitoring capabilities on a per-patient and not a per-bed/wheelchair, gurney, etc basis. Furthermore, a PMD may be assigned to patient at check-in and recovered at discharge. Specialized docks may be present only at intake and discharge points such that the PMD's may only be enabled or transferred at these points, thereby providing enhanced stability to the system.

According to various embodiments of the invention, a dock enables medical devices to be connected to the dock, thereby simplifying a patient's transition from a bed to a wheelchair and back again, for example. Furthermore, by controlling PMD behavior from a dock, the PMD becomes more user-friendly for clinical personnel, who may not be technically inclined or trained, because the clinical personnel are not require to manually change settings or connect devices.

According to various embodiments of the invention, the system described above may enable incremental and/or varied behavior of a PMD based on the context of its use. A PMD may be configured for the behavior that is preferable depending on the associated context simply by docking in new location. For example, simply switching from a bedside dock to a wheelchair dock may configure a device to change a geo-location sampling rate a discussed above, or it may enable a PMD to stop acquiring data from biometric devices attached to the bed, such as pulse-ox meters, and begin acquiring biometric data from devices attached to the wheelchair.

According to various embodiments of the invention, a PMD may transfer data wirelessly to either a dock or to an external receiver, which may be associated with an external processor such as a centralized computer system, using various methods including, but not limited to, infrared or radio frequency (RF). Any suitable RF system that conforms to FCC requirements and power requirements may be used. The PMD may use the BLUETOOTH standard. BLUETOOTH is generally a 2.4 GHz wireless technology employed to transport data between cellular phones, notebook PCs, and other handheld or portable electronic gear at speeds of up to 1 megabit per second. The BLUETOOTH standard is designed to be broadband compatible and capable of simultaneously supporting multiple information sets and architecture, transmitting data at relatively high speeds, and providing data, sound, and video services on demand. Other suitable wireless communication standards and methods now existing or developed in the future are contemplated in the present invention. In addition, embodiments are contemplated that operate in conjunction with a BLUETOOTH or BLUETOOTH-like wireless communication standard, protocol, or system where a frequency other than 2.4 GHz is employed, or where infrared, optical, or other communication means are employed in conjunction with BLUETOOTH or BLUETOOTH-like wireless RF communication techniques. Additionally, or in the alternative, a PMD may transmit data in compliance with the IEEE 802.15 WPAN standard.

According to various embodiments of the invention, a PMD may include a transceiver such as a wireless, bi-directional, transceiver suitable for short-range, omni-directional communication that allows ad hoc networking of multiple transceivers for purposes of extending the effective range of communication. Ad hoc networking refers to the ability of one transceiver to automatically detect and establish a digital communication link with another transceiver. The resulting network, known as a piconet, enables each transceiver to exchange digital data with the other transceiver.

According to various aspects of the invention, an Electrically Erasable Programmable Read-Only Memory (hereinafter, “EEPROM”) may be included in the device as a non-volatile storage chip. EEPROMs typically come in a range of capacities from a few bytes to over 128 kilobytes and are often used to store configuration parameters. In some systems, EEPROMs have been used in lieu of CMOS nonvolatile BIOS memory. For example, in personal computers EEPROMs are often used to store the BIOS code and related system settings. EEPROMs may be erased electrically in-circuit, and may be used for 100,000 erase-write cycles or more. EEPROMs typically retain data when power is not supplied. EEPROM chips may use serial interfaces to connect to other devices.

According to various embodiments of the invention, a PMD and/or a dock may be configured to be programmed using an external computer or other processor. The device may be connected to the computer using a hard-wired system or a wireless system. Such wired or wireless communication of data and/or voice may include, but are not limited to, the following: 802.11 wireless network protocol; Bluetooth protocol; 802.15.4 protocol; wired network protocol; telephone line; infrared data transfer; acoustic coupler; RS-232 serial transfer; manual transfer via memory card, Near Field Communication or RFID.

The heart of an RFID system lies in an information carrying tag called an RFID tag, which functions in response to a coded RF signal received from a base station or an RFID reader. Typically, an RFID tag reflects an incident RF carrier back to the base station or reader, and information is transferred as the reflected signal is modulated by the RFID tag according to its programmed information protocol.

Generally an RFID tag has a semiconductor chip having RF circuits, various logic circuitry, and a memory, as well as an antenna, a collection of discrete components, such as capacitors and diodes, a substrate for mounting the components, interconnections between components, and a physical enclosure. Two types of RFID tags are generally used, active tags, which utilize batteries, and passive tags, which are either inductively powered or powered by RF signals used to interrogate the tags; passive tags do not use a battery.

A radio frequency (RF) identification system generally consists of an RF reader and a plurality of RF tags. In a typical configuration, the reader utilizes a processor which issues commands to an RF transmitter and receives commands from the RF receiver. The commands serve to identify tags present in the RF field.

In some implementations, commands exist to gather information from the tags. In more advanced systems, commands exist which output information to the tags. This output information may be held temporarily on the tag, it may remain until written over, or it may remain permanently on the tag.

The RF transmitter of the reader generally encodes commands from the processor, modulates the commands from a base band to the radio frequency, amplifies the commands, and then passes the commands to the RF antenna. The RF receiver receives the signal at an antenna, demodulates the signal from the RF frequency to the base band, decodes the signal, and passes it back to the processor for processing. The reader's antenna is usually capable of transferring RF signals to and from a plurality of tags within the RF signal range.

Passive RFID tags generally have no internal power supply. A minute electrical current induced in an antenna by incoming radio frequency signals generally provide enough power for an integrated circuit (hereinafter, “IC”), e.g. a CMOS based IC, in the tag to power up and transmit a response. Most passive tags provide a signal by backscattering the carrier signal received from an RFID reader. In order to utilize backscattering, the antenna of a passive RFIC tag is generally configured to collect power from the incoming signal and to transmit an outbound backscatter signal. The response of a passive RFID tag is not limited to an ID number (e.g. GUID); many RFID tags contain nonvolatile memory devices, such as EEPROMs, for storing data. Common passive RFID tags may commonly be read at distances ranging from about 10 cm to a several meters, depending on the chosen radio frequency and antenna design/size.

Unlike passive RFID, tags, active RFID tags generally have internal power sources which are used to power incorporated ICs that generate an outgoing signal. Active tags may be more reliable (e.g. fewer errors) than passive tags because the active tags may conduct a session with a reader where error correction and/or signal verification may be utilized. Active tags may also transmit at higher power levels than passive tags, allowing them to be more effective in “RF challenged” environments such as water or metal, and over greater distances. Many active RFID tags have practical ranges of hundreds of meters, and a battery life of up to 10 years.

In a typical RFID system, an RFID reader may contain an antenna packaged with a transceiver and decoder. The RFID reader may emit a signal activating the RFID tag so it can read data from and write data to the RFID tag. When an RFID tag passes through the electromagnetic zone, it detects the reader's activation signal and is activated. The reader may then decode the data encoded in the tag's IC and may either store the data of pass the data to a processor.

Depending on the type of system utilizing the RFID reader, application software on a host computer may process the data in a myriad of different ways, e.g. the data may be filtered to reduce redundant readings of the same tag and to form a smaller and more useful data set.

Near Field Communication (hereinafter, “NFC”) is a new, short-range wireless connectivity technology that evolved from a combination of existing contact free identification and interconnection technologies. Products with built-in NFC may simplify the way consumer devices interact with one another, helping speed connections, receive and share information and even making fast and secure payments.

Commonly operating at 13.56 MHz and transferring data at up to 424 Kbits/second, NFC provides intuitive, simple, and safe communication between electronic devices. NFC is both a “read” and “write” technology. Communication between two NFC-compatible devices may occur when the devices are brought within approximately four centimeters of one another: a simple wave or touch may establish an NFC connection which is then compatible with other known wireless technologies such as Bluetooth or Wi-Fi. Because the transmission range may be relatively short, NFC-enabled transactions are inherently secure. Also, physical proximity of the device to the reader gives users the reassurance of being in control of the process.

NFC may be used with a variety of devices, from mobile phones that enable payment or transfer information to digital cameras that send their photos to a TV set with just a touch.

According to various embodiments of the invention, a PMD and/or a dock may utilize a transceiver to transmit and/or receive information. Typically, a transceiver is a device that has a transmitter and a receiver which may be combined. Technically, transceivers generally combine a significant amount of the transmitter and receiver handling circuitry. Similar devices may include transponders, transverters, and repeaters. Generally, a transceiver combines both transmission and reception capabilities within a single housing. The term transceiver, as used herein may refer to a device, such as an RFID tag or an NFC device. These devices may receive data over a hardwired connection or a radio frequency connection, as well as through various other types of connection. The devices may transmit information over similar of different connections.

According to various embodiments of the invention, a PMD and/or a dock may utilize a system based on Received Signal Strength Indicator (hereinafter, “RSSI”) technology to determine a location of the device. RSSI is a known term in the field of radio engineering, and is a common feature designed in most radio transceivers systems. In a common dielectric medium, the emission of the radio waves from transmitters the RSSI is known to decay as a power function as the distance between the transmitter and receiver are increased. In the device and method describe wherein the medium is known to be a discontinuous dielectric thereby reducing the decay of the RSSI to a near liner function of the distance between the receiver and transmitter increases.

According to various embodiments of the invention, the device may also contain a geo-locator unit to allow the position of the PMD, and thereby the user, to be determined, tracked and/or monitored. While this unit may involve utilize an RSSI signal as described above, it may also utilize a GPS or similar unit, or a combination thereof.

According to various embodiments of the invention, the device may have a biofeedback unit to measure, record, analyze and/or transmit various parameters related to the user. The parameters may include at least one of the user's pulse, blood pressure, temperature and pulse oxygen level.

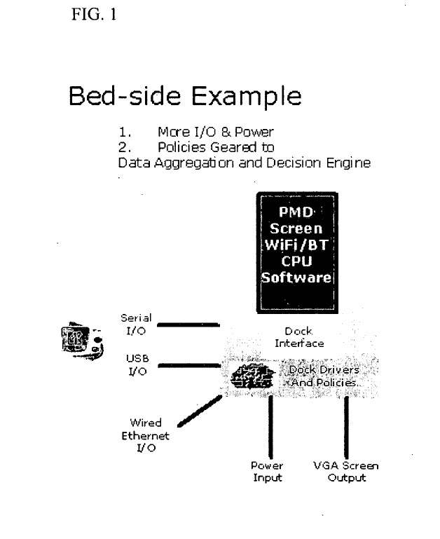

FIG. 1 depicts an exemplary system in which a PMD is attached to a bed-side dock according to an embodiment of the invention. As shown in FIG. 1, a PMD 100 may comprise a screen 101, a data exchange unit using WiFi/Bluetooth 102, a CPU 103 and various software 104. The PMD 100 may be inserted into a dock 110 which comprises a dock interface 111 and various dock drivers and policies 112. Several interfaces 120 are connected to the dock 110, including a serial I/O 121, a USC I/O 122, a wire Ethernet I/O 123, a power input 124 and a VGA screen output 125.

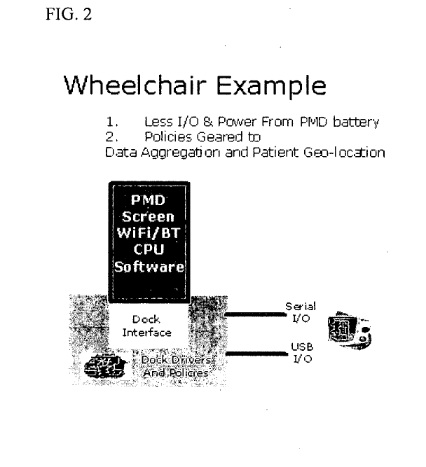

FIG. 2 depicts an exemplary system in which a PMD is attached to a wheelchair dock according to an embodiment of the invention. As shown in FIG. 2, a PMD 200 may comprise a screen 201, a data exchange unit using WiFi/Bluetooth 202, a CPU 203 and various software 204. The PMD 200 may be inserted into a dock 210 which comprises a dock interface 211 and various dock drivers and policies 212. Two interfaces 220 are connected to the dock 210, including a serial I/O 221 and a USC I/O 222.

As would be recognized by one of ordinary skill in the art, FIGS. 1 and 2 merely show embodiments of the invention. The depicted systems may be modified as necessary to perform any combination of the functions described throughout the specification.

We claim:

1. A docking station, comprising:
at least one connector to form a connection between a personal medical device and the docking station; and
a data exchange unit to transmit data to the personal medical device;
wherein the data comprises control information to control at least one operating parameter of the personal medical device.

2. The docking station of claim 1, wherein the connector is to form a wired connection between a personal medical device to the docking station.

3. The docking station of claim 1, wherein the connector is to form a wireless connection between a personal medical device to the docking station.

4. The docking station of claim 1, wherein the data exchange unit receives data from the personal medical device.

5. The docking station of claim 1, wherein the data further comprises geo-location data to calibrate a geo-location unit of the personal medical device.

6. The docking station of claim 1, wherein the operating parameters of the personal medical device comprises at least one of a biometric sampling, a biometric sampling rate, a geo-locator positioning operation, and a geo-locator reporting operation.

7. The docking station of claim 1, wherein the at least one operating parameter of the personal medical device is a transmission state, such that a transmission unit of 2. The docking station of claim 1, the personal medical device is disabled while the personal medical device is connected with the docking station.

8. The docking station of claim 1, wherein the connection uses one of a Bluetooth based technology, an NFC based technology and an RFID based technology.

9. The docking station of claim 1, wherein the connection is only established while the personal medical device is physically connected to the docking station.

10. A system comprising a plurality of the docking stations of claim 1, wherein at least two of the docking stations control the at least one operating parameter to be in a different state.

11. The system of claim 10, wherein the plurality of docking stations are located in a hospital or medical clinic.

12. The system of claim 10, wherein at least one docking station is mounted to a wheelchair.

13. The system of claim 10, wherein at least one docking station is mounted to a bed.

14. The system of claim 13, further comprising a processor unit to receive data from the personal medical device.

15. The system of claim 13, further comprising a processor unit to receive data from the plurality of docking stations.

16. The system of claim 10, wherein the dock is connected to a biometric monitoring device and a patient care device, and wherein the personal medical device is configured to;
monitor the biometric monitoring device,
analyze data received from the biometric monitoring device,
determine which patient care device is attached to the dock,
determine if the patient care device should be controlled based on the analyzed data, and
control the patient care device in response to a determination that the patient care device should be controlled.

17. A method, comprising controlling at least one operating parameter of a personal medical device based on a control signal received from a docking station.

18. The method of claim 17, wherein the operating parameters of the personal medical device comprises at least one of a biometric sampling, a biometric sampling rate, a geo-locator positioning operation, and a geo-locator reporting operation.

19. The method of claim 17, wherein the at least one operating parameter of the personal medical device is a transmission state, such that a transmission unit of the personal medical device is disabled while the personal medical device is connected with the docking station.

20. A method, comprising:
monitoring at least one biometric monitoring device connected to a dock,
analyzing data received from the biometric monitoring device using a personal medical device,
determining at least one patient care device is attached to the dock using a personal medical device,
determining if the patient care device should be controlled based on the analyzed data using a personal medical device, and
controlling the patient care device in response to a determination that the patient care device should be controlled using a personal medical device.

21. The method of claim 20, wherein a manual input is required prior to controlling the patient care device.

22. The method of claim 21, wherein the manual input can be performed at a remote location.
